(19) United States
(12) Patent Application Publication
(10) Pub. No.: US 2013/0044171 A1
(43) Pub. Date: Feb. 21, 2013

(54) RECORDING APPARATUS

(71) Applicants: Tsuneyuki SASAKI, Matsumoto-shi (JP); Yoichi KOBAYASHI, Matsumoto-shi (JP)

(72) Inventors: Tsuneyuki SASAKI, Matsumoto-shi (JP); Yoichi KOBAYASHI, Matsumoto-shi (JP)

(73) Assignee: SEIKO EPSON CORPORATION, Tokyo (JP)

(21) Appl. No.: 13/563,306

(22) Filed: Jul. 31, 2012

(30) Foreign Application Priority Data
Aug. 16, 2011 (JP) 2011-177815

(51) Int. Cl. B41J 2/01

(52) U.S. Cl. 347/102

(57) ABSTRACT

A recording apparatus includes a recording portion that ejects liquid onto a recording medium which is transported in a transportation direction so as to perform recording processing, a first infrared heating portion that is arranged at a recording surface side of the recording medium, and irradiates the recording medium on which the recording processing has been performed by the recording portion with infrared rays having wavelengths which are easy to be absorbed by water contained in the liquid, and a second infrared heating portion that is arranged at the recording surface side of the recording medium at the downstream side with respect to the first infrared heating portion in the transportation direction, and irradiates the recording medium which has been heated by the first infrared heating portion with infrared rays having wavelengths which are easy to be absorbed by a solvent contained in the liquid.

### BACKGROUND

This application claims priority to Japanese Patent Application No. 2011-177815 filed on Aug. 16, 2011. The entire disclosure of Japanese Patent Application No. 2011-177815 is hereby incorporated herein by reference.

1. Technical Field

The present invention relates to a recording apparatus.

2. Related Art

In a printer using ink, if ink is discharged on a recording medium, and then, adjacent ink (dot) is discharged before the ink is dried, inks may mix with each other, resulting in bleeding. With this, there arises a problem in that recording quality is significantly lowered. In order to solve such a problem, a recording medium is required to be heated so as to accelerate fixing of the ink.

In JP-A-2006-224460, an ink jet recording apparatus in which electromagnetic waves are radiated for an amount suitable to a recording mode, types of ink and a recording target medium so as to dry the ink that has been discharged by an ink jet head and adhered to the recording target medium has been disclosed. Further, the following technique has been described in JP-A-2006-224460. That is, infrared rays from a radiation heating unit are divided into components one of which is reflected by a surface portion of ink or a surface of a recording target medium, another component which transmits through the ink and is incident on the recording target medium, and the other component which is absorbed by the ink. The radiation energy which resonates and is adsorbed by the ink may cause molecules of the ink to vibrate. Then, frictional heat is generated among the molecules (atoms) of the ink with the vibration so that the ink can be dried with the frictional heat.

Further, the heating unit as described in JP-A-2006-224460 decreases the (loss) component which is reflected by the ink surface and the (recording target medium heating) component that transmits through the ink while increasing the (heating) component which is absorbed by the ink in the radiation energy as illustrated in FIG. 8 in JP-A-2006-224460. That is to say, the heating unit is provided such that most of the electromagnetic waves are adsorbed by the ink, and employs electromagnetic waves having a wavelength of equal to or lower than 3.0 μm in order to heat the ink adhered to the surface of the recording target medium intensively rather than to heat the recording target medium itself. With this configuration, the ink is dried without taking a recording mode and a type of the medium into considerations.

In an ink jet recording apparatus using ink, a drying process and a curing process are needed. In the drying process, moisture of the ink is evaporated in order to prevent the ink from aggregating and bleeding after the ink has landed. In the curing process, the ink is polymerized and cured so as to be fixed.

However, in JP-A-2006-224460, since the drying process and the curing process are performed at the same time without being distinguished from each other, the curing process is performed before the ink is dried sufficiently. As a result, there arises a problem in that the ink is fixed in a bleeding state and recording quality may be deteriorated.

Further, in JP-A-2006-224460, the drying process and the curing process of ink are performed at the same time using the electromagnetic waves having the wavelength of equal to or lower than 3.0 μm. Therefore, energy loss at the time of heating becomes larger in comparison with a case where electromagnetic waves suitable to each process are used, resulting in a problem that peripheral members of the heating portion are also heated.

### SUMMARY

An advantage of some aspects of the invention is to provide a recording apparatus which can suppress energy for drying and curing ink and reduce influence of heat on peripheral members.

A recording apparatus according to an aspect of the invention includes a recording portion that ejects liquid onto a recording medium which is transported in a transportation direction so as to perform recording processing, a first infrared heating portion that is arranged at a recording surface side of the recording medium, and irradiates the recording medium on which the recording processing has been performed by the recording portion with infrared rays having wavelengths which are easy to be absorbed by water contained in the liquid, and a second infrared heating portion that is arranged at the recording surface side of the recording medium at the downstream side with respect to the first infrared heating portion in the transportation direction, and irradiates the recording medium which has been heated by the first infrared heating portion with infrared rays having wavelengths which are easy to be absorbed by a solvent contained in the liquid.

In the recording apparatus according to the aspect of the invention, it is preferable that the first infrared heating portion irradiate the recording medium with infrared rays having a maximum wavelength in a band of 2 to 6 μm.

In the recording apparatus according to the aspect of the invention, it is preferable that the second infrared heating portion irradiate the recording medium with infrared rays having a maximum wavelength in a band of 4 to 12 μm.

It is preferable that the recording apparatus according to the aspect of the invention further include a third infrared heating portion that is arranged at the recording surface side of the recording medium at the upstream side with respect to the recording portion in the transportation direction, and irradiates the recording medium before the recording processing is performed by the recording portion with infrared rays having wavelengths which are easy to be absorbed by the recording medium.

In the recording apparatus according to the aspect of the invention, it is preferable that the third infrared heating portion irradiate the recording medium with infrared rays having a maximum wavelength in a band of 4 to 8 μm.

### BRIEF DESCRIPTION OF THE DRAWINGS

The invention will be described with reference to the accompanying drawings, wherein like numbers reference like elements.

FIG. 1 is a perspective view illustrating a printer according to an embodiment of the invention.

FIG. 2 is a cross-sectional view illustrating a schematic configuration of the printer.

FIG. 3 is a perspective view illustrating a part of a first heating unit.

### DESCRIPTION OF EXEMPLARY EMBODIMENTS

Hereinafter, each embodiment of a recording apparatus according to the invention is described with reference to drawings. It is to be noted that in the drawings to be used in the following description, the scale of each member is appropriately changed in order to make each member be in recognizable size.

In the embodiment, an ink jet printer (hereinafter, simply referred to as printer 1) is exemplified as a recording apparatus according to the invention.

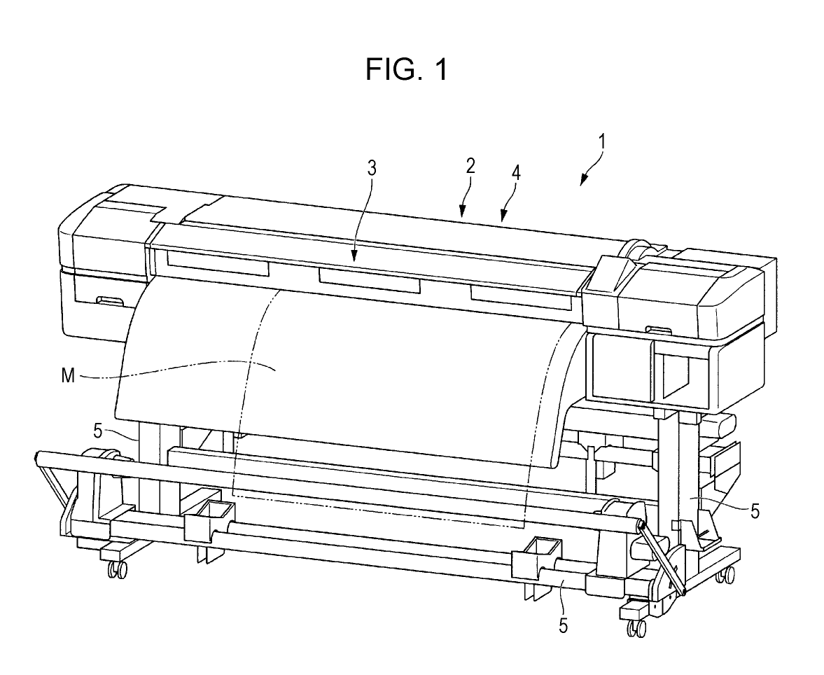

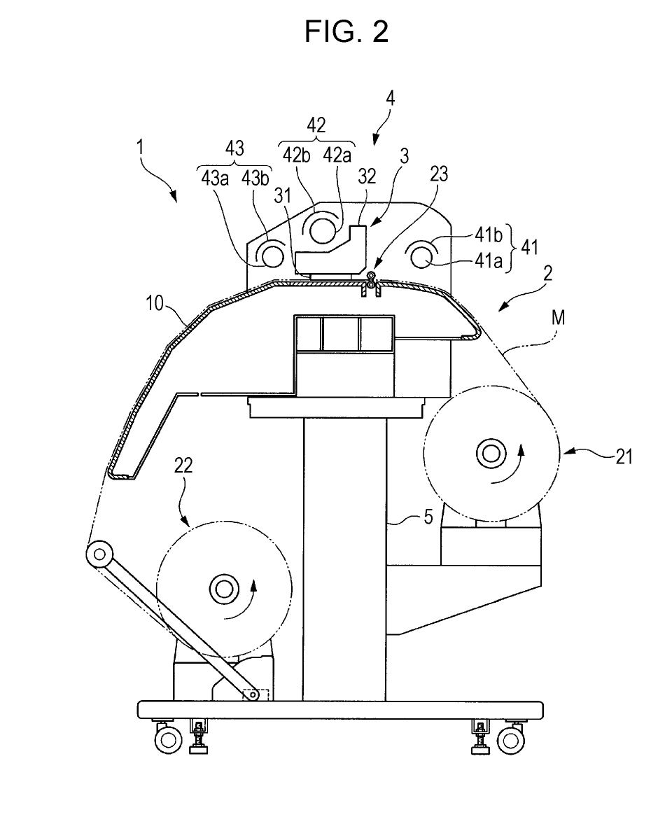

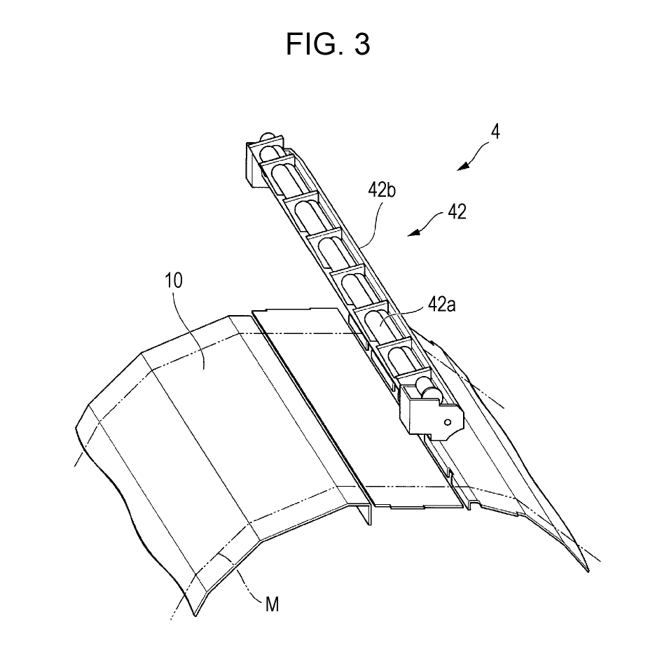

FIG. 1 is a perspective view illustrating an external appearance of the printer 1 according to an embodiment of the invention. FIG. 2 is a cross-sectional view illustrating a schematic configuration of the printer 1. FIG. 3 is a perspective view illustrating an infrared heater 42a and the like of a first heating unit 42.

The printer (recording apparatus) 1 is a large format printer (LFP) which handles a relatively large-sized medium M. The medium M is a belt-like medium having a width of approximately 64 inches, for example, and is formed with a vinyl chloride-based film or paper, for example.

The printer 1 includes a transporting portion 2, a recording portion 3, and a heating portion 4. The transporting portion 2 transports the medium M with a roll-to-roll method. The recording portion 3 ejects ink (for example, aqueous pigment ink) as liquid onto the medium M so as to record an image, text, and the like. The heating portion 4 heats the medium M. These constituent portions are supported by a main unit frame 5.

The transporting portion 2 includes a winding-out portion 21, a winding-up portion 22, and a transportation roller pair 23. The winding-out portion 21 feeds out the medium M wound in a roll form. The winding-up portion 22 winds up the fed medium M in a roll form. The transportation roller pair 23 holds the medium M on a transportation path between the winding-out portion 21 and the winding-up portion 22 and applies a transportation force. The winding-out portion 21, the winding-up portion 22, and the transportation roller pair 23 are driven by a motor and a reducer (not illustrated).

The recording portion 3 has an ink jet head 31 and a carriage 32. The ink jet head 31 ejects ink onto the medium M on the transportation path at the downstream side with respect to the transportation roller pair 23. The ink jet head 31 is mounted on the carriage 32 and the carriage 32 can reciprocate in a width direction. The ink jet head 31 includes a plurality of nozzles and can eject aqueous ink which requires osmotic drying or evaporation drying based on the relationship between the media M and the aqueous ink.

A medium supporting portion 10 constitutes a part of the transportation path of the medium M. The medium supporting portion 10 supports the medium M between the winding-out portion 21 and the winding-up portion 22 in such a manner that the medium M is curved so as to be swelled to the upper side.

The heating portion 4 includes a preheating unit 41, a first heating unit 42, and a second heating unit 43. The preheating unit 41 preheats the medium M at the upstream side with respect to a position at which the recording portion 3 is provided in the transportation direction. The first heating unit 42 heats the medium M from an upper surface side (opposite to a surface opposed to the medium M) of the recording portion 3. The second heating unit 43 heats the medium M at the downstream side with respect to the position at which the recording portion 3 is provided in the transportation direction.

The preheating unit (third infrared heating portion) 41 includes a long infrared heater 41a as a heat source and a reflecting plate 41b. The reflecting plate 41b reflects heat rays emitted from the infrared heater 41a to all directions so as to make the heat rays be irradiated onto a recording surface of the medium M intensively. The infrared heater 41a is arranged at a position opposed to the medium M along a width direction (direction orthogonal to the transportation direction) of the medium M such that both ends of the infrared heater 41a in a lengthwise direction thereof substantially correspond to both ends of the medium M in the width direction.

The medium (recording medium) M gets wrinkled if the medium M contains moisture. Therefore, the infrared heater 41a irradiates the medium M with middle-infrared rays so as to heat and dry the medium M (preheating process). This makes wrinkles on the medium M be smooth.

In order to evaporate the moisture contained in the medium M, the medium M must be heated. Therefore, a peak wavelength (maximum wavelength) of the middle-infrared rays to be emitted from the infrared heater 41a corresponds to a maximum absorption wavelength of the medium M or is in a wavelength band (light wavelength band in which the medium M is easy to absorb the middle-infrared rays) in the vicinity of the maximum absorption wavelength. When the medium M is a paper medium, it is sufficient that the peak wavelength is in a band of 4 to 8 μm, for example.

Then, the medium M is heated by the preheating unit 41 before being heated by the first heating unit 42 so that the wrinkles are made smooth. With this, a difference in thermal expansion of the medium M between before and after the medium M is heated by the first heating unit 42 is suppressed, thereby reducing expansion and contraction of the medium M.

The first heating unit (first infrared heating portion) 42 heats the medium M from an upper surface side (opposite to a surface opposed to the medium M) of the recording portion 3 at the downstream side with respect to the preheating unit 41 in the transportation direction. That is to say, the first heating unit 42 is arranged at substantially the same position as the carriage 32 in the transportation direction and heats the medium M from the recording surface side.

The first heating unit 42 includes a long infrared heater 42a as a heat source and a reflecting plate 42b. The reflecting plate 42b reflects heat rays emitted from the infrared heater 42a to all directions so as to make the heat rays be irradiated onto the recording surface of the medium M intensively. The infrared heater 42a is arranged at a position opposed to the medium M along the width direction (direction orthogonal to the transportation direction) of the medium M such that both ends of the infrared heater 42a in a lengthwise direction thereof substantially correspond to both ends of the medium M in the width direction.

The infrared heater 42a is formed by a halogen heater tube on which infrared coating having a thickness of equal to or smaller than 100 μm has been applied onto a surface thereof, for example. The infrared heater 42a is excellent in heat responsivity (high-speed responsivity) and has a reduced heat capacity. Therefore, ink immediately after landed is prevented from aggregating and bleeding, in addition, safety in an emergency is ensured.

The infrared heater 42a dries ink landed on the medium M by irradiating the medium M with middle-infrared rays (drying process).

In order to evaporate moisture contained in the ink, a peak wavelength of the middle-infrared rays to be emitted from the infrared heater 42a corresponds to a maximum absorption wavelength of water contained in the ink or is in a wavelength band (light wavelength band in which the water contained in the aqueous ink is easy to absorb the middle-infrared rays) in the vicinity of the maximum absorption wavelength. In the embodiment, it is sufficient that the peak wavelength is in a band of 2 to 6 μm, for example.

The moisture contained in the ink is not required to be evaporated by 100%. It is sufficient that the moisture contained in the ink is evaporated by equal to or higher than 80% until the medium M is transported to the second heating unit 43 from the first heating unit 42.

The second heating unit (second infrared heating portion) 43 heats the medium M from the recording surface side at a position which is slightly separated from the first heating unit 42 to the downstream side in the transportation direction. A distance between the first heating unit 42 and the second heating unit 43 is determined such that a moisture evaporation amount of the medium M at the time when the medium M has reached the second heating unit 43 is optimum in consideration of a transportation speed of the medium M.

The second heating unit 43 includes a long infrared heater 43a as a heat source and a reflecting plate 43b. The reflecting plate 43b reflects heat rays emitted from the infrared heater 43a to all directions so as to make the heat rays be irradiated onto the recording surface of the medium M intensively. The infrared heater 43a is arranged at a position opposed to the medium M along the width direction (direction orthogonal to the transportation direction) of the medium M such that both ends of the infrared heater 43a in a lengthwise direction thereof substantially correspond to both ends of the medium M in the width direction.

The infrared heater 43a is formed by a sheathed heater of which surface is baked with an Inconel material, for example. Note that the sheathed heater is a heater obtained by inserting a heat-resistant insulator coated electrical heating wire into a metal tube and putting filler into a gap therebetween. The infrared heater 43a irradiates the medium M with far-infrared rays in order to heat the medium M at a higher temperature than that in the drying process. Then, the ink landed on the medium M is polymerized so as to be cured (curing process).

The aqueous pigment ink is a mixture of a pigment having a dye and a solvent as liquid which dissolves the pigment. It is important to heat the solvent in order to polymerize and cure the aqueous ink. Then, in order to polymerize and cure the aqueous ink, a peak wavelength of the far-infrared rays to be emitted from the infrared heater 43a corresponds to a maximum absorption wavelength of the solvent contained in the aqueous ink or is in a wavelength band (light wavelength band in which the solvent in the aqueous ink is easy to absorb the far-infrared rays) in the vicinity of the maximum absorption wavelength. In the embodiment, it is sufficient that the peak wavelength is in a band of 4 to 12 μm, for example.

Since transmission energy of the far-infrared rays is small, the far-infrared rays reach an ink layer on the medium M only and do not penetrate into the medium M. Therefore, in the curing process, the medium M is heated at a higher temperature than that in the drying process but the transmission energy of the far-infrared rays does not penetrate into the medium M, thereby suppressing expansion and contraction of the medium M. This makes it possible to reduce energy loss further.

In the printer configured as described above, if a job instruction to start printing is input, the heating portion 4 operates in the following manner.

At first, if the job instruction is input, the medium M is transported to a heating region of the preheating unit 41 of the heating portion 4 and the infrared heater 41a is driven. Therefore, the middle-infrared rays from the infrared heater 41a are irradiated onto the medium M directly or after being reflected by the reflecting plate 41b. With this, the medium M is heated and wrinkles thereon are made smooth. Then, the medium M on which wrinkles have been made smooth is transported to the recording portion 3.

If the medium M is transported to a printing region on the medium supporting portion 10, the ink jet head 31 of the recording portion 3 starts printing processing on the medium M. The ink jet head 31 performs the printing processing while reciprocating in the width direction of the medium M in a state of being mounted on the carriage 32.

The infrared heater 42a of the first heating unit 42 is provided at the upper side (opposite to a surface opposed to the medium M) of the carriage 32. When the carriage 32 retreats from a recording region (ink landing region) in the width direction of the medium M, the infrared heater 42a heats the recording region with the middle-infrared rays having the wavelengths of which peak wavelength is included in a band of 2 to 6 μm.

Therefore, water molecules contained in the aqueous ink landed on the medium M vibrate as evaporation and drying are accelerated with frictional heat by the vibration. Accordingly, the aqueous ink is prevented from bleeding.

The temperature of the medium M is high while being transported from the first heating unit 42 to the second heating unit 43. Therefore, the aqueous ink on the medium M is sufficiently dried until the medium M reaches the second heating unit 43. For example, moisture contained in the aqueous ink is evaporated by equal to or higher than 80%.

Further, if the medium M is transported to the second heating unit 43, the infrared heater 43a of the second heating unit 43 heats the medium M with the far-infrared rays having the wavelengths of which peak wavelength is included in a band of 4 to 12 μm. Since the transmission energy of the far-infrared rays is small, the far-infrared rays penetrate into only the ink layer of the medium M and polymerization of the aqueous ink is accelerated. Therefore, the aqueous ink is cured so as to be fixed onto the medium M.

As described above, the printer 1 in the embodiment irradiates the medium M with infrared rays having optimum wavelengths for the drying process and the curing process of ink in turns from the recording surface side. With this, the printer 1 can dry and cure the ink reliably so as to record an image with high quality without bleeding in comparison with a case where infrared rays having optimum wavelengths for the drying process and infrared rays having optimum wavelength for the curing process of ink are mixed and irradiated onto the medium M at the same time. Further, the printer 1 makes it possible to suppress energy loss of the far-infrared rays, realize power saving, and minimize an influence of heat on peripheral members of the heating portion 4.

That is to say, in the drying process of ink, the printer 1 irradiates the medium M on which ink has landed with the middle-infrared rays in the light wavelength band (for example, 2 to 6 μm) in which moisture in the ink is easy to absorb the middle-infrared rays. This makes it possible to suppress energy to be used in the drying process to be requisite minimum.

Further, the printer 1 can realize high-speed responsivity and reduced heat capacity by using the halogen heater. Therefore, since ink is dried fast, the ink can be prevented from aggregating and bleeding even if immediately after landed. In addition, heat capacity is reduced so that safety in an emergency at the time of malfunction or the like is ensured.

It is to be noted that the infrared heater 42a to be used in the drying process is not limited to the halogen heater. It is sufficient that the infrared heater 42a can emit middle-infrared rays in the wavelength band of (2 to 6 μm).

Further, in the curing process of ink, the printer 1 irradiates the medium M on which ink has landed with the far-infrared rays in the light wavelength band (for example, 4 to 12 μm) in which a solvent in the aqueous ink is easy to absorb the far-infrared rays. With this, transmission energy of the far-infrared rays does not reach the medium M and is made to reach an ink layer only. This makes it possible to suppress energy to be used in the polymerization and the curing of ink to be requisite minimum.

In addition, in the curing process, the medium M is heated at a higher temperature than that in the drying process. However, the transmission energy of the far-infrared rays reach to the ink layer only, thereby suppressing expansion and contraction of the medium M due to the heating at high temperature.

Further, the printer 1 irradiates the medium M with the middle-infrared rays in the light wavelength band (for example, 4 to 8 μm in a case where the medium M is a paper medium) in which the medium M is easy to absorb the middle-infrared rays in the preheating process before the recording processing by the recording portion 3. With this, wrinkles on the medium M are made smooth so that expansion and contraction of the medium M due to a difference in thermal expansion between before and after the drying process can be suppressed.

When an area (preheating area) on which the preheating unit 41 can be installed is small, it is preferable that the infrared heater 41a be used in consideration of heat responsivity as in the embodiment.

However, when the preheating area is sufficiently large, a heating mechanism which can heat the medium M from the (rear surface) side opposite to the recording surface of the medium M by heat conduction may be provided instead of the infrared heater 41a (preheating unit 41). That is to say, in the preheating process, a configuration of the heating mechanism or a heating surface of the medium M is not limited particularly as long as wrinkles on the medium M can be made smooth with preheating. For example, a heating mechanism which heats the medium M from both of the recording surface side and the side opposite to the recording surface side may be employed.

In the embodiment, description has been made illustrating a case where the recording apparatus is the printer 1, as an example. However, the recording apparatus is not limited thereto and may be an apparatus such as a copying machine or a facsimile.

Further, as the recording apparatus, a recording apparatus which ejects and discharges fluid other than ink may be employed. The invention can be applied to various types of recording apparatuses including recording heads which discharge a trace amount of liquid droplets, for example. Note that the terminology “liquid droplets” represents a state of liquid which is discharged from the above recording apparatus. For example, a granule form, a teardrop form, and a form that pulls tails in a string-like form therebehind are included as the liquid droplets. The terminology “liquid” here represents materials which can be ejected by the recording apparatus. For example, any materials are included as long as the materials are in a liquid phase. For example, materials in a liquid state having high viscosity or low viscosity or a fluid state such as a sol, gel water, other inorganic solvents, an organic solvent, a solution, a liquid resin or a liquid metal (molten metal) can be included as the liquid. Further, the liquid is not limited to liquid as one state of a material but includes a solution, dispersion or a mixture of particles of a functional material made of a solid material such as pigment or metal particles. Further, ink (aqueous pigment ink) as described in the above embodiment is exemplified as a representative of the liquid. The medium M encompasses functional paper which thermally expands to be thin, a substrate, a metal plate, and the like in addition to paper and a plastic film such as a vinyl chloride-based film. Further, the medium M is not limited to a belt-like medium and may be a recording medium which has been previously cut.

What is claimed is:

1. A recording apparatus comprising:
a recording portion that ejects liquid onto a recording medium which is transported in a transportation direction so as to perform recording processing;
a first infrared heating portion that is arranged at a recording surface side of the recording medium, and irradiates the recording medium on which the recording processing has been performed by the recording portion with infrared rays having wavelengths which are easy to be absorbed by water contained in the liquid, and a second infrared heating portion that is arranged at the recording surface side of the recording medium at the downstream side with respect to the first infrared heating portion in the transportation direction, and irradiates the recording medium which has been heated by the first infrared heating portion with infrared rays having wavelengths which are easy to be absorbed by a solvent contained in the liquid.

2. The recording apparatus according to claim 1,
wherein the first infrared heating portion irradiates the recording medium with infrared rays having a maximum wavelength in a band of 2 to 6 μm.

3. The recording apparatus according to claim 1,
wherein the second infrared heating portion irradiates the recording medium with infrared rays having a maximum wavelength in a band of 4 to 12 μm.

4. The recording apparatus according to claim 1, further including a third infrared heating portion that is arranged at the recording surface side of the recording medium at the upstream side with respect to the recording portion in the transportation direction, and irradiates the recording medium before the recording processing is performed by the recording portion with infrared rays having wavelengths which are easy to be absorbed by the recording medium.

5. The recording apparatus according to claim 1,
wherein the third infrared heating portion irradiates the recording medium with infrared rays having a maximum wavelength in a band of 4 to 8 μm.
